(19) United States
(12) Patent Application Publication
(10) Pub. No.: US 2012/0136287 A1
(43) Pub. Date: May 31, 2012

(54) VAGINAL TISSUE REGENERATION DEVICE AND METHOD FOR REGENERATION OF VAGINAL LINING USING VIBRATION THERAPY

(76) Inventors: Ellen L. Barnard, Madison, WI (US); Myrtle Wilhite, Madison, WI (US)

(21) Appl. No.: 13/305,250

(22) Filed: Nov. 28, 2011

Related U.S. Application Data
(60) Provisional application No. 61/417,753, filed on Nov. 29, 2010.

(51) Int. Cl. A61H 1/00

(52) U.S. Cl. 601/46

(57) ABSTRACT

A vaginal regeneration device is provided and method of promoting regeneration of vaginal tissue is provided. The method includes providing a patient having a vagina in need of vaginal tissue regeneration vaginal lubricant and a vaginal regeneration device. The vagina is lubricated and the regeneration device is inserted into the patient's vagina, wherein the vibrating mechanism is activated, allowing the vibrations to contact the vaginal wall for a therapeutic period of time. The device includes a shaft having a first end and a second end, a tapered insertion at said first end of said shaft and an end cap at said second end of the shaft, and a vibrating mechanism within the shaft. The invention further is directed to kits for promoting regeneration of vaginal tissue comprising at least two vaginal regeneration devices having different diameters along the majority of the length of the shaft.

### CROSS-REFERENCE TO RELATED APPLICATIONS

This application claims priority from U.S. Provisional Application Ser. No. 61/417,753, filed Nov. 29, 2010, entitled VAGINAL TISSUE REGENERATION DEVICE AND METHOD FOR REGENERATION OF VAGINAL LINING USING VIBRATION THERAPY, the contents of which is hereby incorporated in its entirety by reference.

### FIELD OF INVENTION

The present invention relates generally to therapeutic apparatus for promoting regeneration of vaginal tissue and methods of promoting the regeneration of vaginal tissue, and more particularly to vibrating devices used primarily for regeneration of vaginal lining and methods of using vibrating apparatus for the regeneration of vaginal lining.

### BACKGROUND

A variety of factors can contribute to cause degeneration or weakening of vaginal tissue. These factors may include, among other causes, changes related to aging, cancer treatments, and cancer related surgery.

One of the physiologic features of menopause is that blood flow to the vagina ebbs. Atrophic vaginitis, a condition caused by a decrease in estrogen production after menopause which subsequently leads to a decrease in blood flow in vaginal tissues, results in poor tissue regeneration and an increasingly fragile vaginal structure. This decrease in blood flow is largely due to the waning vasodilation effect of estrogen. Although one generally thinks of estrogen's “classical” genomic steroidal actions, estrogen also affects the body through “rapid-action” mechanisms. One of the best-described rapid actions of estrogen is the ability to stimulate endothelial nitric oxide synthase (hereafter “eNOS”) in vascular endothelial cells, causing increased blood flow through increased nitric-oxide dependent vasodilation.

Lower blood flow leads to 1) decreased skin repair capability, 2) decreased flexibility of connective tissue in the vulva and vagina, 3) decreased vaginal lubrication, and 4) more difficult arousal activation. This is in part because other consequences of depressed estrogen involve an increase in inflammatory reactive oxygen species (vascular, mitochondrial and angiotensin II-related production), depressed mitochondrial function, and decreased tissue regeneration and repair, including depressed collagen synthesis by fibroblasts.

Although systemic administration of estrogen is sometimes used to combat these issues, other women need or prefer to use nonhormonal alternatives for renewing or maintaining their vulvovaginal health.

Radiation therapy to the pelvic region often results in changes to the vagina such as thinning of the vaginal epithelium and fibrosis, in addition to foreshortening and stenosis of the vagina. Radiation also disturbs the future ability of the vaginal tissue to form new blood vessels (angiogenesis) and diminishes the size and number of small blood vessels within the vagina, decreasing vaginal lubrication production.

Chemotherapeutic treatment modalities can also cause adverse changes to the vagina. Tamoxifen is a selective estrogen receptor blocker which can block the rapid action effects of estrogen, resulting in decreased vaginal lubrication and decreased vaginal blood flow. Tamoxifen also enhances aging of the vaginal mucosa and reduction of vaginal flexibility. Over time continued therapy with Tamoxifen may make vaginal penetration uncomfortable or, in some cases, impossible without treatment.

A physical alternative is the use of dilators. However, known dilators have several drawbacks. First, many dilators have a large amount of taper along a significant part of their length. This can represent a problem because some women need a device that can penetrate the complete length of the vaginal canal without significant change in diameter. Unlike surgical or radiotherapy interventions where women sometimes experience a foreshortening of the vagina, women transitioning through menopausal changes (naturally or from medical therapy) are more likely to experience a decrease in diameter along the whole length of the vagina. These women need consistently narrow devices that are long enough to penetrate the full length of the contracted portion of the vagina. A dilator that has any significant taper along the shaft would either be too narrow toward the tip to be effective deep in the vagina, or would be too wide toward the base and uncomfortable in use.

Second, although they are called “dilators,” the common therapeutic use, and thus the aim of the design of many dilators, is not actually to widen the vagina but to deepen it. Where damaged or weakened vaginal walls are a focus of treatment it is desirable to increase passive blood flow, and thus tissue regeneration, by gently and repeatedly distending the vaginal wall laterally rather than just by depth of penetration. However, many devices intended for vaginal insertion are difficult for all but the most motivated and physically capable women to maneuver from side to side to accomplish the desired low frequency repetition of pressure laterally on the vaginal walls. Some women with very severe thickening of the vaginal wall from radiation simply cannot manipulate the dilators laterally successfully as the angles, physical coordination and/or flexibility required are too much for some women to accomplish. This is compounded for women of advancing age who suffer from arthritis issues preventing them from comfortably gripping the dilator, or from flexing their spine enough to reach their vulva comfortably.

The difficulties and limitations suggested in the preceding are not intended to be exhaustive, but rather are exemplary of the devices which demonstrate that, despite attention in the art to improving vaginal therapeutic treatment devices, the devices and methods in the art will admit to useful improvements.

### SUMMARY OF THE INVENTION

It has been discovered that low frequency vibration therapy facilitates angiogenesis, thereby synergistically boosting the healing effects of massage therapy using a vaginal insertion device to assist in vaginal regeneration. It is therefore an object of the present invention to provide vaginal regeneration devices that have a generally consistent length and minimal tapering along most of the portion that is intended to be inserted into the vagina (the shaft), that can be made to vibrate at a low frequency, preferably in the range of 500 to 7,000 revolutions per minute (rpm), and more preferably in the range of 1,000 to 1,700 rpm, and permitting that frequency to be varied within a therapeutic range by the user, and that can be made in a variety of diameters to accommodate different women's vaginal dimensions, including a very small diameter shaft, preferably in the range of 15 mm to 21 mm, to accommodate more severely constricted vaginal walls.

It is another object of the present invention to provide methods of promoting regeneration of vaginal tissue comprising applying a lubricating material to the vagina of a female patient desiring vaginal tissue regeneration or to a vibrating device made for vaginal insertion that can be made to vibrate at low frequency, preferably in the range of 500 to 7,000 rpm, and more preferably in the range of 1,000 to 1,700 rpm, inserting the device and permitting the device to vibrate against the walls of the vagina for a therapeutic period of time, preferably for at least 5 minutes, and repeating this process on a frequent basis as tolerated by the patient, preferably at least once a day.

One embodiment of the present invention is a method of promoting regeneration of vaginal tissue by providing a patient having a vagina in need of vaginal tissue regeneration, vaginal lubricant, and a vaginal regeneration device, the device including a shaft having a first end and a second end, a tapered insertion at said first end of the shaft, an end cap at said second end of the shaft, and a vibrating mechanism within the shaft. The method further includes applying the vaginal lubricant to the vagina or to the regeneration device, inserting the regeneration device into the vagina, and activating the vibrating mechanism. In one or more examples of embodiments, the method further includes allowing the regeneration device to remain in the vagina for between 1 and 20 minutes, and more preferably for at least 5 minutes.

In one example of an embodiment of a method of promoting regeneration of vaginal tissue, the shaft of the vaginal regeneration device has a length of between 110 mm and 190 mm. In another example of an embodiment, the shaft has a length of between 115 mm and 140 mm.

In one example of an embodiment of a method of promoting regeneration of vaginal tissue, the vibrating mechanism provides vibrations at a speed of between 500 rpm and 7,000 rpm, and more preferably the vibrating mechanism provides vibrations at a speed of between 1,000 rpm and 1,700 rpm.

In one example of an embodiment of a method of promoting regeneration of vaginal tissue, the shaft has an average diameter of less than 21 mm. In another example of an embodiment, the shaft has an average diameter in the range from 21 mm to 27 mm. In another example of an embodiment, the shaft has an average diameter in the range from 27 mm to 33 mm. In another example of an embodiment, the shaft has an average diameter in the range from 33 mm to 42 mm.

In another example of an embodiment of a method of promoting regeneration of vaginal tissue, the shaft has an outer surface that comprises a smooth low friction material.

In another embodiment of the present invention, a vaginal regeneration device includes a shaft having a first end, a second end, and a diameter of less than 23 mm along the majority of the length of the shaft, a tapered insertion at the first end of the shaft, an end cap at the second end of the shaft, and a vibrating mechanism within the shaft, wherein the vibrating mechanism produces vibrations within the range of 500 to 7,000 rpm. In an example of an embodiment, the vibrating mechanism produces frequencies within the range of 1,000 to 1,700 rpm.

In another embodiment of the present invention, a vaginal tissue regeneration kit includes vaginal lubrication and a vaginal tissue regeneration device. The vaginal tissue regeneration device comprises a shaft having a first end and a second end, a tapered insertion at the first end of the shaft and an end cap at the second end of the shaft. The vaginal tissue regeneration device has an average diameter of less than 23 mm along the majority of the length of the shaft and a vibrating mechanism within the shaft that produces vibrations within the range of 500 to 7,000 rpm.

In one example of an embodiment of the kit, the vibrating mechanism produces frequencies within the range of 1,000 to 1,700 rpm.

In another embodiment of the present invention, a set of vaginal tissue regeneration devices is provided. The set of devices includes a first vaginal tissue regeneration device and a second vaginal tissue regeneration device, each device comprising a shaft having a first end and a second end, a tapered insertion at the first end of the shaft, an end cap at the second end of the shaft, and a vibrating mechanism within the shaft that produces vibrations within, the range of 500 to 7,000 rpm, wherein the average diameter of the shaft of the first vaginal tissue regeneration device is at least 4 mm smaller than the average diameter of the shaft of the second vaginal tissue regeneration device.

In another example of embodiments, the set of vaginal tissue regeneration devices further comprises a third vaginal tissue regeneration device comprising a shaft having a first end and a second end, a tapered insertion at the first end of the shaft, an end cap at the second end of the shaft, and a vibrating mechanism within the shaft that produces vibrations within the range of 500 to 7,000 rpm, wherein the diameter of the shaft of the third vaginal tissue regeneration device is at least 4 mm larger than the diameter of the shaft of the second vaginal tissue regeneration device. In one example of embodiments, the first, second and third vaginal tissue regeneration devices are each different colors.

These and other aspects of the present invention will become more apparent from the following detailed description of various embodiments of the present invention when viewed in conjunction with the accompanying drawings.

### BRIEF DESCRIPTION OF DRAWINGS

FIG. 1 is an isometric view according to one or more examples of embodiments of a vaginal regeneration device.

FIG. 2 is an isometric view according to one or more examples of embodiments of a vaginal regeneration device.

FIG. 3 is an isometric view according to one or more examples of embodiments of a vaginal regeneration device.

FIG. 4 is an elevation view of the vaginal regeneration device of FIG. 1.

FIG. 5 is an elevation view of the vaginal regeneration device of FIG. 2.

FIG. 6 is an elevation view of the vaginal regeneration device of FIG. 3.

FIG. 7 is a sectional elevation view of the vaginal regeneration device of FIG. 1.

FIG. 8 is a sectional elevation view of the vaginal regeneration device of FIG. 2.

FIG. 9 is a sectional elevation view of the vaginal regeneration device of FIG. 3.

FIG. 10 is a partial sectional view of the base of the vaginal regeneration device taken along line 10-10 of FIG. 7.

FIG. 11 is an isometric view according to one or more examples of embodiments of a vaginal regeneration device.

FIG. 12 is an elevation view of the vaginal regeneration device of FIG. 11.

FIG. 13 is a sectional elevation view of the vaginal regeneration device of FIG. 11.

### DETAILED DESCRIPTION

The following presents one or more examples of embodiments of a vaginal tissue regeneration device 10.

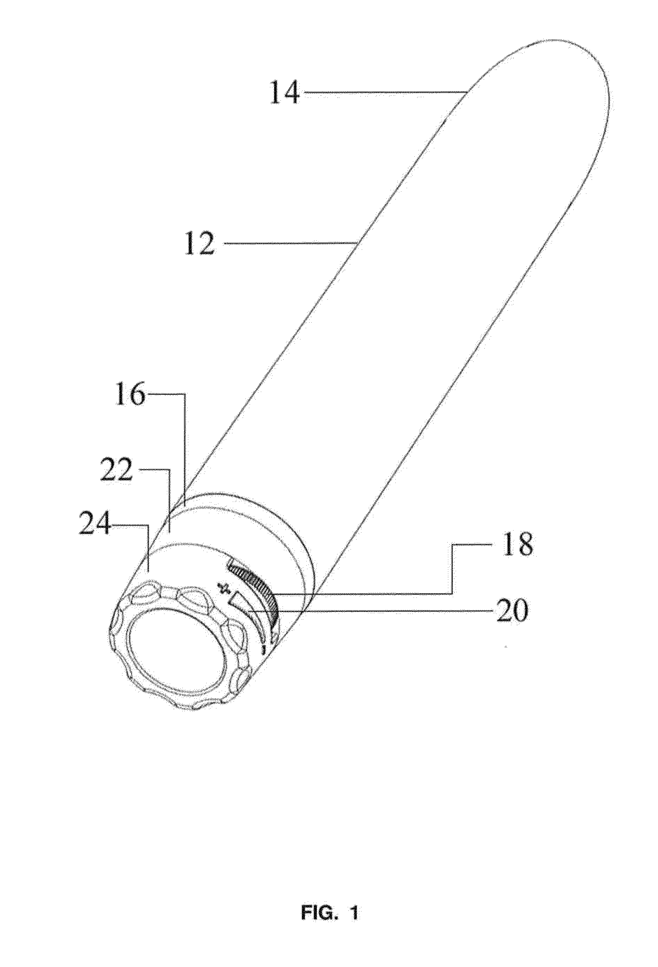

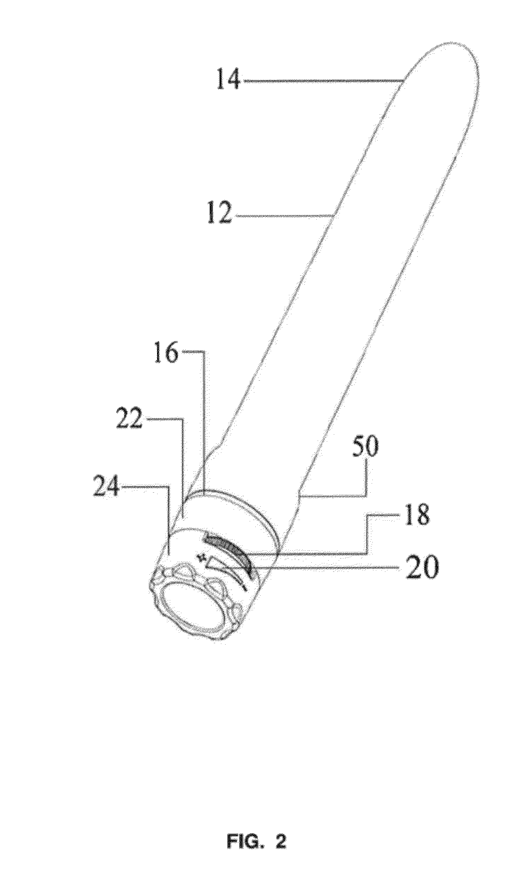

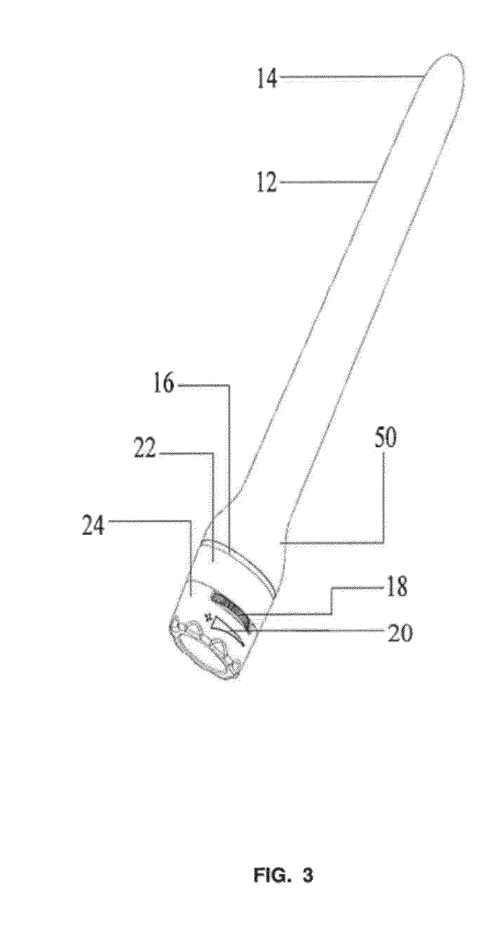

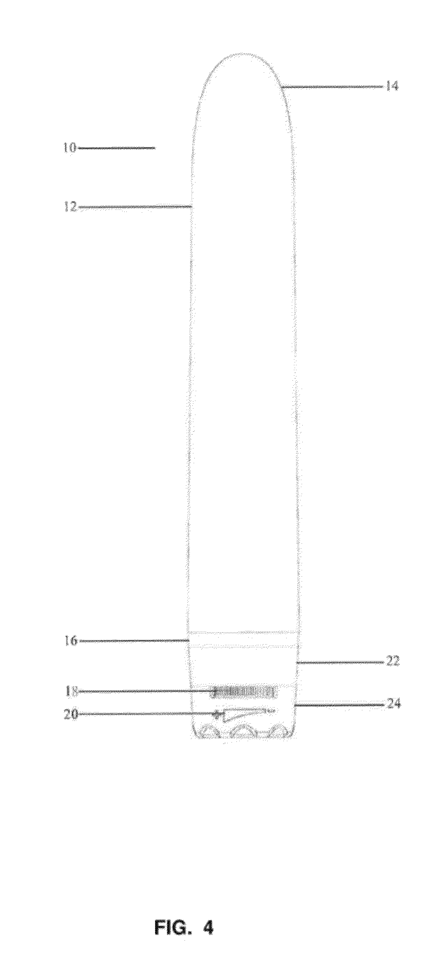

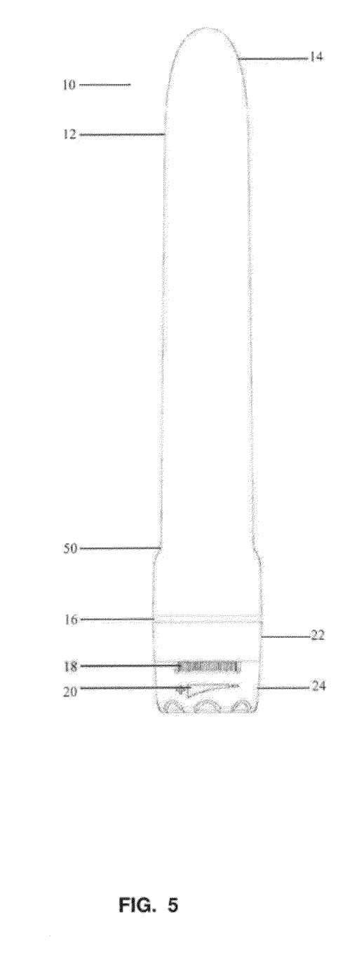

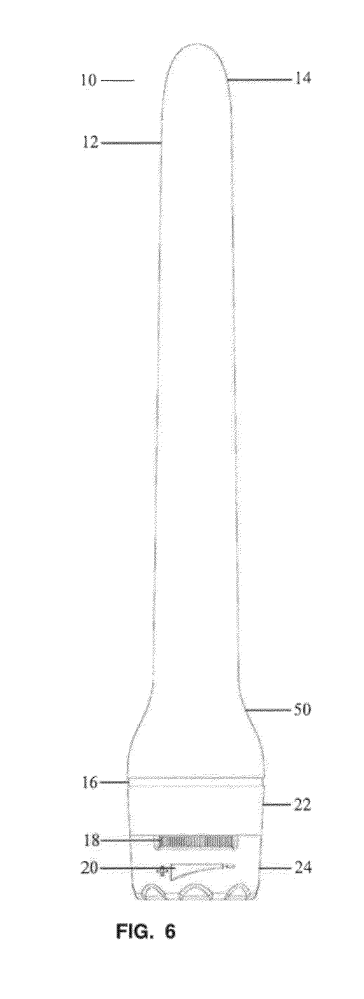

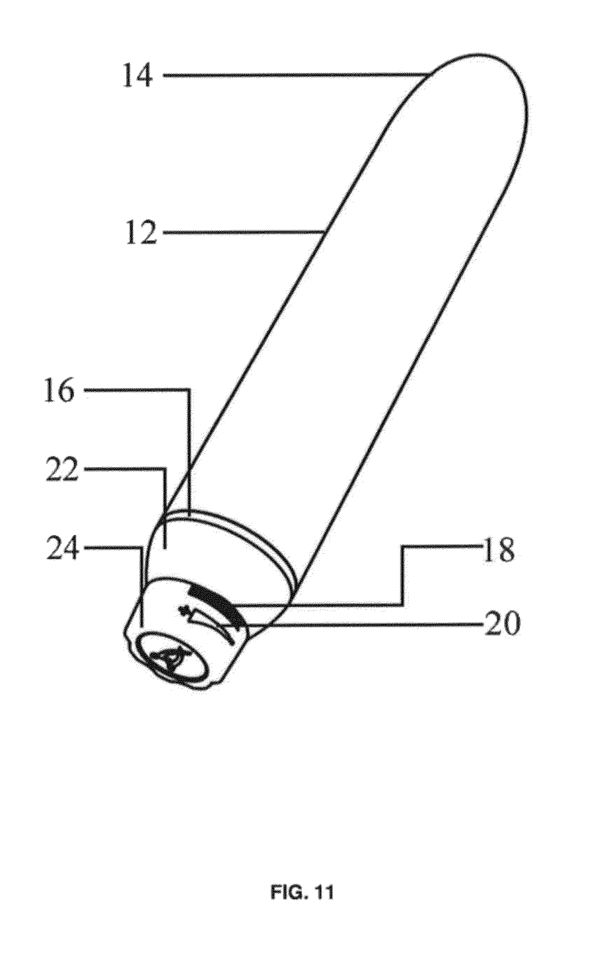

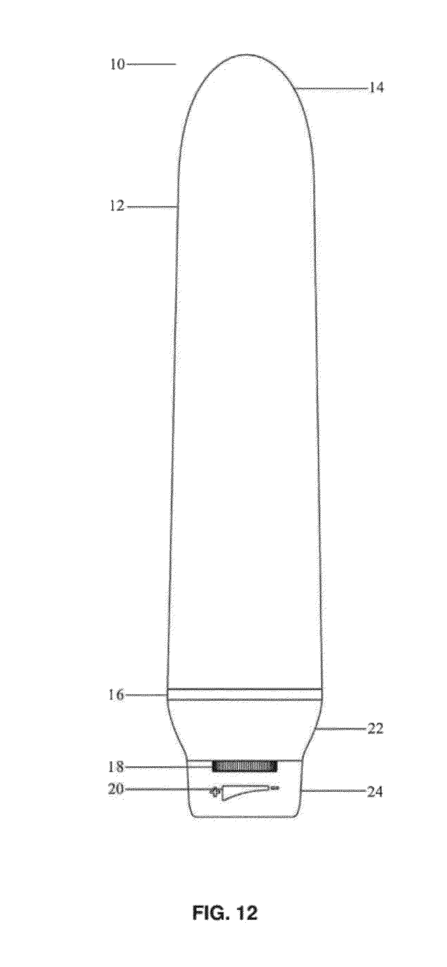

As illustrated in FIGS. 1-9 and 1113, the vaginal tissue regeneration device 10 is provided in various sizes, including “maxi” or large (FIGS. 1, 4 and 7), “midi” or medium (FIGS. 2, 5 and 8), “slim” or small (FIGS. 3, 6 and 9), and “maxi plus” or extra large (FIGS. 11, 12 and 13).

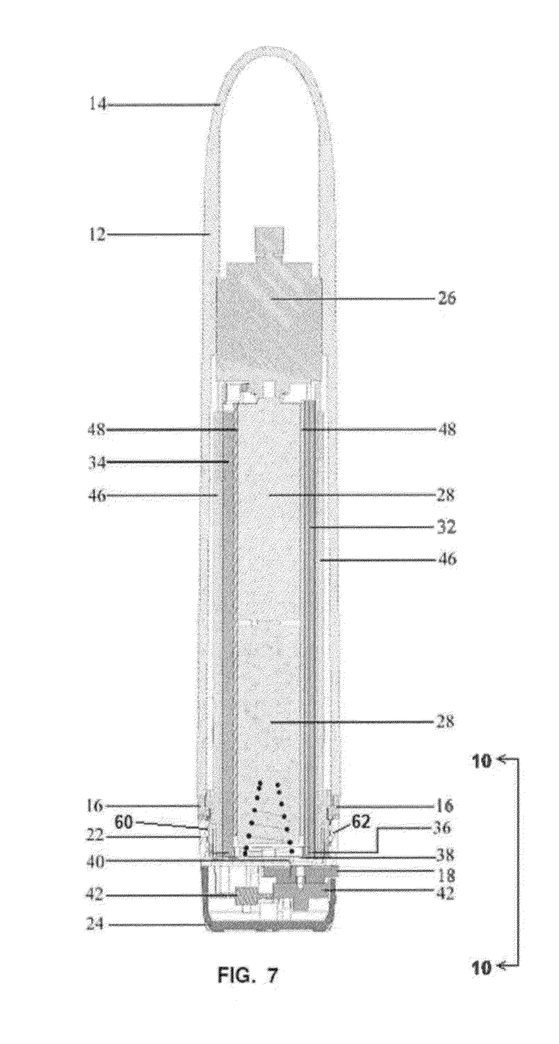

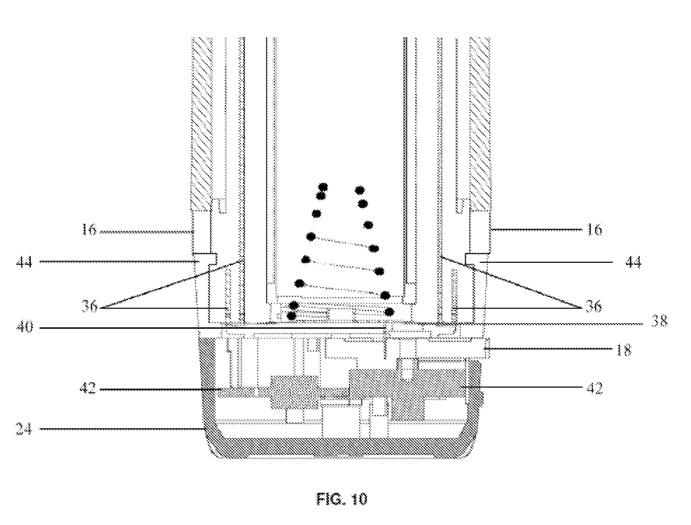

Referring to FIGS. 1-9 and 11-13, the vaginal tissue regeneration device 10 includes a shaft 12 which is preferably elongated, substantially cylindrical and hollow. Shaft 12 has a first end coupled to a tapered insertion 14 which may be tapered or rounded for facilitating insertion into a body cavity or orifice. Shaft 12 and tapered insertion 14 together form a housing. Shaft 12 also has a second end at which an O-ring 16 is provided between the housing and an end cap 22, O-ring 16 is preferably made of rubber or another nontoxic flexible water resistant material to prevent moisture from entering the interior of the housing. End cap 22 is removably coupled to the housing to permit access to the cavity within the housing. For example, as shown in FIG. 7, the housing may include external helical threads or a male portion 60 which correspond to and may be received by internal helical threads or a female portion 62 provided within end cap 22. In one or more examples of embodiments, and as shown in FIG. 10, end cap 22 is removably coupled to the housing by an end cap locking mechanism knob 44. End cap locking mechanism knob 44 may include a projection or extension which projects inward or toward shaft 12 or away from the outer surface of end cap 22. In use, end cap 22 may be positioned over or about the base or second end of the shaft 12. As the user slides end cap 22 onto the second end of shaft 12, end cap locking mechanism knob 44 is received by and slides within a corresponding first groove provided on the outer surface or circumference of the second end or base of shaft 12. The first groove extends or runs parallel to the long axis of shaft 12 or perpendicular to the cross-sectional radius of shaft 12. Once end cap 22 reaches the maximum distance end cap locking mechanism knob 44 can slide within the first groove or reaches a second groove, end cap 22 is rotated to thread end cap locking mechanism knob 44 along the second groove. Generally, the second groove extends approximately perpendicular to the first groove. Stated otherwise, the second groove extends perpendicular to the long axis of shaft 12 or parallel to the cross-sectional radius of shaft 12. Upon receipt of end cap locking mechanism knob 44 by the second groove, end cap 22 is removably or reversibly locked onto shaft 12.

An end cap exterior housing 24 is coupled to end cap 22 opposite the shaft 12 end and contains the internal circuitry of the device or unit. A variable speed control dial 18 may be provided or positioned on the end cap exterior housing 24 to permit a user to turn a vibration mechanism 26 (shown in FIGS. 7-9 and 13) in the vaginal tissue regeneration device 10 on and off, and to vary the speed or intensity or frequency or revolutions per minute of the vibration. In one or more examples of embodiments, the variable speed control dial 18 controls a rheostat (not shown) which activates and adjusts the speed or intensity or revolutions per minute of the vibration. In one or more examples of embodiments, a speed variation indicator 20 may be provided that directs the user how to activate and adjust the vibration frequency using the variable speed control dial 18.

Referring to FIGS. 2, 3, 5, and 6, the vaginal tissue regeneration device 10 may include a tapered neck 50 provided toward the second end of the shaft 12 between the shaft 12 and the end cap 22. The tapered neck 50 permits the shaft 12 for medium and smaller sizes to have a smaller diameter along the majority of the length of the shaft 12, which is appropriate for more constricted vaginal openings, while maintaining a larger diameter base which gives sufficient space for control circuitry within the end cap 22 and end cap exterior housing 24 as well as providing a larger base for the user to grip. In larger devices, such as those shown in FIGS. 11, 12 and 13, the shaft 12 has a large enough diameter that the end cap 22 is tapered to link the larger diameter shaft 12 to the smaller diameter end cap exterior housing 24. In one or more examples of embodiments, women in need of vaginal tissue regeneration will first select the vaginal regeneration device 10 having a size that she can insert into her vagina without increasing damage to the tissue, and then, as her vaginal tissue regenerates and her vaginal opening enlarges she may choose to select a slightly larger vaginal regeneration device to continue treatment. For this reason it is contemplated that more than one size of the vaginal regeneration devices, preferably at least 3 or 4 sizes, would be provided to a user sequentially or all together in a kit to permit gradual increase in diameter of the device as the vaginal tissue improves.

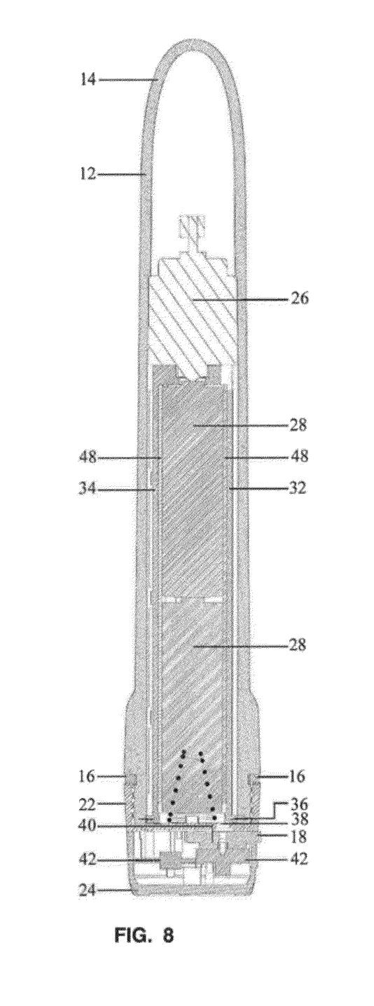

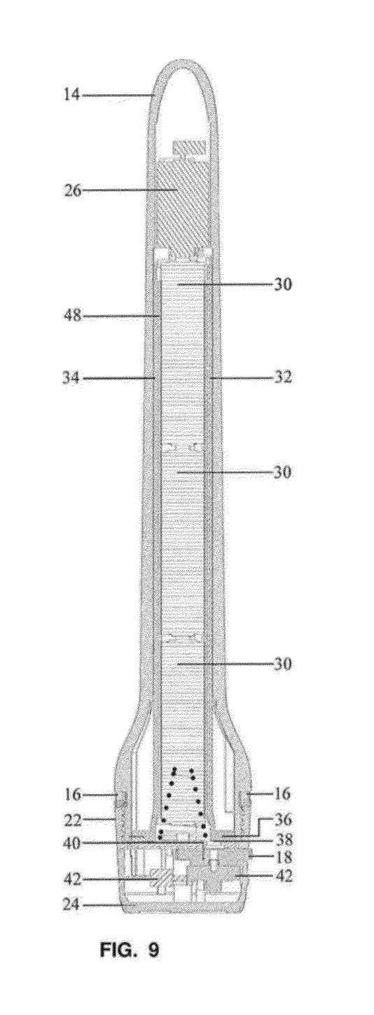

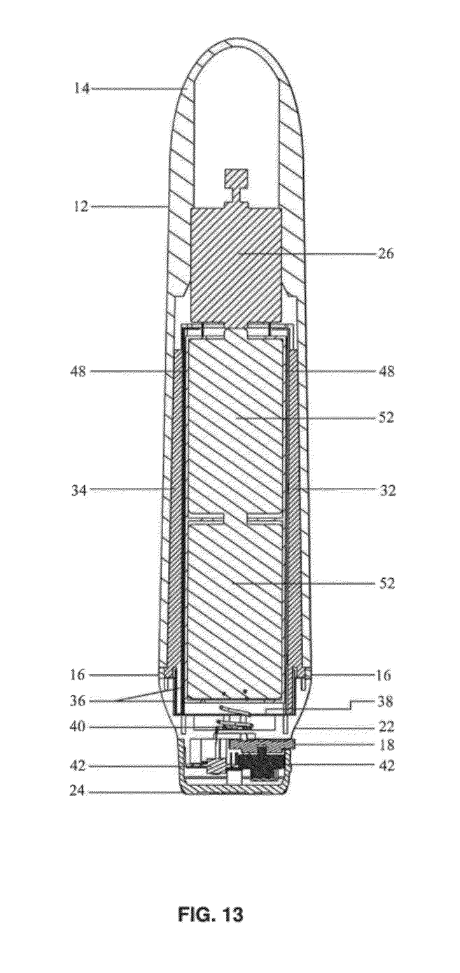

FIGS. 7, 8, 9 and 13 are sectional views of large, medium, small, and extra large vaginal regeneration devices 10 of the present invention, respectively. Referring to the Figures, vibration mechanism or assembly 26 is provided within the housing, preferably more toward the first end or tapered insertion 14 than the second end or end cap 22. The vibration assembly 26 may include a motor that drives an eccentric counter weight. A power source 28, 30, 52 is provided to drive the vibration assembly 26. The power source 28, 30, 52 may be one or more battery cells. For example, as shown in FIGS. 7 and 8, the power source 28 includes two AA battery cells 28. As shown in FIG. 9, the power source 30 includes three AAA battery cells 30. Referring to FIG. 13, the power source 52 includes two C battery cells 52. The different sized power sources 28 may be necessary as some larger battery cells will not fit in some housings having diameters which are sufficiently small to be used by patients early in their treatment to achieve vaginal tissue regeneration. Within shaft 12 is a battery housing 32, 34 situated between the interior surface of the shaft 12 and the power source 28. The battery housing 32, 34 is illustrated in the Figures as a first side battery housing 32 and a second side battery housing 34. Generally, the battery housing fully encircles the power source 28 and is substantially cylindrical in shape.

Referring to FIGS. 7-10 and 13, motor joints 36 connect the motor of the vibration mechanism 26 to the Printed Circuit Board Assembly 42 (hereafter “PCBA”) via or through the Printed Circuit Board joint 38 (hereafter “PCB joint”). Motor joints 36 may be formed of two long and/or slender pieces of metal, PCB joint 38 may be formed of two slender and/or segmented circular metal contacts electrically connected to PCBA 42. A spring joint 40 may be provided in the end cap to electrically connect power source 28, 30, 52 to PCBA 42 when a power source 28, 30, 52 is provided in shaft 12. Spring joint 40 may be formed of a metal spring and associated slender pieces of metal.

As illustrated in FIGS. 7-9 and 13, an insulator 48 may be provided within battery housing 32, 34 and extend about or encircle power source 28, 30, 52. Insulator 48 may serve to reduce “rattling” or other sounds caused by vibration of battery or power source 28, 30, 52 during operation of the device 10. Excess noise, such as that produced by battery rattling, can be a deterrent to use, which can adversely affect treatment. Insulator 48 may be composed of any heat stable insulative material with noise dampening effects. In one or more examples of embodiments, insulator 48 is composed of Ethylene Vinyl Acetate.

Referring to FIGS. 7-9, a hollow inner housing 46 may be provided within shaft 12. Inner housing 46 receives and securely houses power source 28, 30 in embodiments of device 10 that utilize a power source 28, 30 which is sufficiently smaller than the inner diameter of shaft 12. Inner housing 46 effectively provides a smaller inner circumference of shaft 12.

In operation and use, one or more examples of embodiments of the vaginal tissue regeneration device 10 described herein may be inserted in the vagina of a woman desiring to regenerate an aging, scarred, constricted or otherwise damaged vaginal tissue. After lubrication had been applied to either the vagina, the vaginal regeneration device or both, the vaginal regeneration device may be held within the vagina for a period of time, for example preferably at least 5 minutes. During at least part of the time the vaginal regeneration device is held within the vagina, the vibrating mechanism is producing low frequency vibrations, for example, preferably in the range of approximately 500 to 7,000 rpm, and more preferably in the range of 1,000 to 1,700 rpm. In one or more examples of embodiments these steps are repeated once daily for the first one to three months, then at least three times weekly thereafter, with daily application offering the best outcome.

While any biologically compatible lubricant is acceptable for use in methods of the present invention, individual sexual lubricant moisturizing capacities vary widely, with some common lubricants having an osmolality that leaves the skin drier and more fragile than before application. In one or more examples of embodiments, the devices and methods of the present invention are used with lubricants that have an osmolality that does not have an adverse effect on the skin. In addition, in one or more examples of embodiments, lubricants are used which offer both moisturizing and sealing properties to allow for the most efficacious use of the regeneration device. Any lubricants with these properties may be used with the regeneration device.

In one or more examples of embodiments, as initial therapy is performed when the tissues are most vulnerable and weak, the application of a moisturizing lubricant may be performed with a gentle non-traumatic, non-shear manual pressing into the skin of the vaginal walls. This has the added benefit of mechanically exchanging capillary blood and lymph, and beginning the return of blood flow. This massage and lubricant application is performed from the clitoral hood to the perineum and the large labia to the vaginal introitus. Once this application is non-tender to touch, therapy with the wand series may begin and continue into the vaginal space.

Because some women experience significant foreshortening of the vaginal space as well as a constriction of diameter from scar formation after traumatic penetration or radiation therapy, these women may need a smaller sized vaginal regeneration device for initial use. As comfort increases and vaginal skin condition improves, the woman can increase the wand size to improve flexibility for penetration or medical examination. Thus, in one or more examples of embodiments of the present invention, the vaginal regeneration devices may be offered in a variety of sizes so that the patient may use the appropriate size for her stage of healing.

In one or more examples of embodiments, vaginal regeneration devices may be offered in the a variety of average shaft diameter sizes (outer diameter). For example, the Slim may be provided with an average shaft diameter of preferably between 15 mm and 23 mm, and more preferably of between 16 mm and 20 mm. The Midi may be provided with an average shaft diameter of preferably between 23 mm and 28 mm, and more preferably of between 24 mm and 27 mm. The Maxi may be provided with an average shaft diameter of preferably between 28 mm and 33 mm, and more preferably of between 29 mm and 33 mm. The Maxi-Plus may be provided with an average shaft diameter of preferably between 33 mm and 42 mm, and more preferably of between 34 mm and 41 mm.

In one or more examples of embodiments, the vaginal regeneration devices may be offered in the following average shaft diameter sizes (outer diameter), wherein the first measurement represents the approximate diameter of the narrowest part of shaft 12 that does not include tapered insertion 14, and the second measurement represents the approximate diameter of the thickest part of shaft 12 where it meets tapered connection 50 or, where there is no tapered connection 50, end cap 22: Slim: 16 mm/20 mm, Midi: 24 mm/27 mm, Maxi: 29 mm/33 mm, and Maxi-Plus: 34 mm/41 mm. In one or more examples of embodiments, the devices of varying sizes are provided in different colors to permit the user to easily distinguish which size to use.

The vaginal regeneration devices of the present invention may have a generally consistent length and minimal tapering along the shaft. In one or more examples of embodiments, the shaft diameter (outer diameter) decreases by less than 8 mm along its length. For smaller sized devices, where the shaft has an average diameter of 33 mm or less, in one or more examples of embodiments, the shaft diameter (outer diameter) decreases by less than 6 mm along its length. In one or more examples of embodiments, where the average shaft diameter is less than 23 mm, shaft diameter (outer diameter) decreases by less than 4 mm along its length.

Women often experience a decrease in vaginal stretch diameter, but may or may not experience any reduction in length. Pelvic radiotherapy patients often experience severe shortening, thickening of the wall and reduction in diameter, often referred to as stenosis, while menopausal women may experience vaginal wall thinning with stenosis but without foreshortening of the vaginal depth. Because of this person-specific need, the vaginal regeneration devices of the present invention are preferably designed to be of sufficient length to penetrate the full depth of most women's vaginas so that the user may choose the appropriate depth of penetration dependent on her unique circumstances. In one or more examples of embodiments, the housing length is preferably in the range of approximately 110 mm to 190 mm, and more preferably in the range of approximately 115 mm and 140 mm. The values referred to in this disclosure for the length of the shaft 12 do not include either the length of the tapered insertion 14 or, where applicable, the length of the tapered neck 50.

Because each person experiences genital vibration uniquely, it is preferable that the actual frequency is chosen by the user for comfort in use, within a given range.

The vaginal tissue regeneration methods and devices of the present invention can be used in a doctor's office or hospital, but have been designed to be particularly useful for home-based therapies, for example to moisturize and recondition the fragile surface of the vaginal epithelium, increase vaginal blood flow by increasing vibratory sheer stress induced release of eNOS, and to rehabilitate the underlying collagen support of the vaginal dermis.

Low frequency vibration applied to tissue increases blood circulation by increasing capillary dilation, which increased blood flow in turn increases the consumption of oxygen and nutrients by muscles and thereby speeding the regeneration process.

Utilizing low Hertz (Hz) frequency encourages Nitric Oxide dependent blood flow without inducing high shear forces at the delicate vaginal epithelium area such that remediation is possible without continued superficial trauma. The vibrations are preferably in the range of 500 rpm to 7,000 rpm, and more preferably in the range of 1,000 rpm to 1,700 rpm for therapeutic purposes. The vaginal tissue regeneration methods of the present invention also provide symptomatic improvement without the risk of hormonal exposure as used in other treatment methods, or their concomitant side-effects.

It is important for efficacy that the portions of the devices of the present invention that are inserted into the vagina have a low friction surface, with imperfections, for example seams or other irregularities, minimized. This serves to prevent further damage to already delicate tissues. The housing of devices of the present invention is preferably made of a chemically stable, relatively inert, resilient material. Materials that might result in toxicity to the user are preferably avoided. The housing of the device is preferably made of some millable resilient material, and the material is preferably water resistant. Without limiting the present invention to any particular resilient material, hard plastic such as ABS plastic, acrylic or Lucite are acceptable materials, with medical grade plastic being preferable.

The vibrating mechanism 26 used in devices of the present invention is commonly comprised of an eccentric weight attached to an electric motor, which is either attached to a battery or can be connected via an electrical cord to a source of electricity, such as a wall outlet. As electricity stimulates the motor to rotate the eccentric mass within the housing of the vaginal regeneration device, the action generates vibrations in the direction perpendicular to the long axis of the shaft, or parallel to the cross sectional radius of the shaft, thereby producing a lateral movement that, when the device is placed in the vagina, will provide the desired repetitive gentle pressure on the walls of the vagina to encourage increased blood circulation to the area. By varying the electrical motor and mechanical weight specifications, one can generate a wide range of vibration frequencies and amplitudes.

There are several advantages to the vaginal tissue regeneration device and associated system. Massage gradually introduced directly to aging, damaged or constricted vaginal tissue increases capillary blood flow, which restores regenerative function and results in thicker, more flexible vaginal tissue. Low hertz vibration, preferably in the range of approximately 500 to 7,000 rpm, and more preferably in the range of 1,000 to 1,700 rpm, provides deeper vibratory penetration with less superficial friction, causing improvement in blood flow within the vaginal tissue without further damaging the vaginal surface. Over time, this therapy allows for comfortable vaginal penetration during sexual intercourse, as well as facilitating comfortable pelvic exams by health care providers.

In addition to rebuilding skin integrity and thickness, vibrating massage during dilator therapy for cancer patients who have undergone vaginal or pelvic radiation reduces the stiffness of scar tissue, again allowing comfortable vaginal penetration during sexual intercourse and facilitating comfortable pelvic exams by health care practitioners.

The vulva may also be affected by menopause, radiotherapy or other sources of damage such that remediation of epidermal and dermal damage is preferably addressed prior to therapy within the vagina. Thus, in the beginning of treatment the focus is preferably on renewing the integrity of the skin and replacing moisture with a genital-safe lubricant.

It is further advantageous for the device to have an adjustable switch that can be used to activate the vibrating motor as well as to adjust the frequency of vibration so that each user can set the appropriate frequency for their therapeutic needs.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, coupled, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred or examples of embodiments, persons skilled in the art will recognize that changes may be made in form and detail without departing from the spirit and scope of the invention.

The various embodiments and aspects of embodiments of the invention disclosed herein are to be understood not only in the order and context specifically described in this specification, but to include any order and any combination thereof. Whenever the context requires, all words used in the singular number shall be deemed to include the plural and vice versa. Whenever the context requires, all options that are listed with the word “and” shall be deemed to include the world “or” and vice versa, and any combination thereof. The titles of the sections of this specification and the sectioning of the text in separated paragraphs are for convenience of reference only and are not to be considered in construing this specification. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements.

In the drawings and specification, there have been disclosed embodiments of the invention, and although specific terms are employed, the terms are used in a descriptive sense only and not for purposes of limitation, the scope of the invention being set forth in the following claims. It must be understood that the illustrated embodiment has been set forth only for the purposes of example and that it should not be taken as limiting the invention.

In the claims which follow, reference characters used to designate claim steps are provided for convenience of description only, and are not intended to imply any particular order for performing the steps.

What is claimed is:

1. A method of promoting regeneration of vaginal tissue, comprising:
providing a patient having a vagina in need of vaginal tissue regeneration a vaginal lubricant and a vaginal regeneration device comprising a shaft having a first end and a second end, a tapered insertion at said first end of said shaft, an end cap at said second end of the shaft, and a vibrating mechanism within the shaft;
applying the vaginal lubricant to the regeneration device;
inserting the regeneration device into the vagina; and
activating the vibrating mechanism.

2. The method of claim 1, further comprising allowing the regeneration device to remain in the vagina for between 1 and 20 minutes.

3. The method of claim 1, further comprising allowing the regeneration device to remain in the vagina for at least 5 minutes.

4. The method of claim 1, wherein the shaft has a length of between 110 mm and 190 mm.

5. The method of claim 1, wherein the shaft has a length of between 115 mm and 140 mm.

6. The method of claim 1, wherein the vibrating mechanism provides vibrations at a speed of between 500 rpm and 7,000 rpm.

7. The method of claim 1, wherein the vibrating mechanism provides vibrations at a speed of between 1,000 rpm and 1,700 rpm.

8. The method of claim 1, wherein the shaft has an average diameter of less than 21 mm.

9. The method of claim 1, wherein the shaft has an average diameter in the range from 21 mm to 27 mm.

10. The method of claim 1, wherein the shaft has an average diameter in the range from 7 mm to 33 mm.

11. The method of claim 1, wherein the shaft has an average diameter in the range 13 mm to 42 mm.

12. The method of claim 1, wherein the shaft has an outer surface that comprises a smooth low friction material.

13. A vaginal regeneration device, comprising a shaft having a first end, a second end, and a diameter of less than 23 mm along the majority of the length of the shaft, a tapered insertion at the first end of the shaft and an end cap at the second end of the shaft, and a vibrating assembly provided within the shaft, wherein the vibrating assembly produces vibrations at a frequency within the range of 500 rpm and 7,000 rpm.

14. The device of claim 13, wherein the vibrating mechanism produces vibrations at a frequency within the range of 1,000 rpm and 1,700 rpm.

15. A vaginal tissue regeneration kit, comprising:
a vaginal tissue regeneration device, comprising a shaft having a first end and a second end, a tapered insertion at the first end of the shaft and an end cap at the second end, having an average diameter of less than 23 mm along the majority of the length of the shaft and a vibrating mechanism within the shaft that produces vibrations within the range of 500 rpm and 7,000 rpm; and
vaginal lubrication.

16. The kit of claim 15, wherein the vibrating mechanism produces vibrations at a frequency within the range of 1,000 rpm and 1,700 rpm.

17. A set of vaginal tissue regeneration devices, comprising a first vaginal tissue regeneration device and a second vaginal tissue regeneration device, each vaginal tissue regeneration device comprising a shaft having a first end and a second end, a tapered insertion at the first end of the shaft and an end cap at the second end, and a vibrating mechanism within the shaft that produces vibrations within the range of 500 rpm and 7,000 rpm, wherein the average diameter of the shaft of the first vaginal tissue regeneration device is at least 4 nm smaller than the average diameter of the shaft of the second vaginal tissue regeneration device.

18. The set of vaginal tissue regeneration devices of claim 17, further comprising a third vaginal tissue regeneration device comprising a shaft having a first end and a second end, a tapered insertion at the first end of the shaft and an end cap at the second end, and a vibrating mechanism within the shaft that produces vibrations within the range of 500 rpm and 7,000 rpm, wherein the diameter of the shaft of the third vaginal tissue regeneration device is at least 4 mm larger than the diameter of the shaft of the second vaginal tissue regeneration device.

19. The set of vaginal tissue regeneration devices of claim 17, wherein the first vaginal tissue regeneration device is a different color from the second vaginal tissue regeneration device.
